(19) United States
(12) Patent Application Publication
(10) Pub. No.: US 2002/0027357 A1
(43) Pub. Date: Mar. 7, 2002

(54) Device for holding writing implements

(76) Inventor: Gary F. Lake, Bishop, CA (US)

Correspondence Address: GARY F. LAKE, 235 AVENIDA DEL MONTE, BISHOP, CA, 93514, US

(21) Appl. No.: 09/907,110

(22) Filed: Jul. 16, 2001

Related U.S. Application Data
(60) Provisional application No. 60/219,045, filed on Jul. 18, 2000.

(51) Int. Cl. B65D 85/28; B42D 3/12

(52) U.S. Cl. 281/30; 206/371; 206/214; 281/31; 281/15.1

(57) ABSTRACT

An improved device for holding writing implements. In the application of the preferred embodiment the means for holding is integrated into something else, as into the cover material of a notebook. In the application of embodiment 2 the means for holding is surrounded by an independent holder body material with an adhesive that allows the user to mount the device where considered appropriate, as onto the cover of a notebook. The essence of the invention is the means for holding, a single aperture holder pattern comprising: holding arms and entry ports. Holding arms form up out of a thin, flat base material from opposite longitudinally parallel sides. Holding arms, at each end, transition into entry ports. The entry ports are generally rounded openings of sufficient size: to provide flexibility for holding arms, to distribute the wear-stress of the flexing holding arms, and provide an inviting opening for inserting the writing implement.

### CROSS-REFERENCE TO RELATED APPLICATIONS

This application is entitled to the benefit of Provisional Patent Application Ser. No. 60/219,045, filing date: Jul. 18, 2000.

### BACKGROUND

1. Field of Invention

This invention relates to a device for holding writing implements, specifically to such holders that can be adhered onto, or integrated into other things.

2. Description of Prior Art

Often, when a pen or pencil is needed, they simply aren't there. This has been an ongoing problem, from the caves to boardrooms. A notebook without a pen is useless, as is a pencil without paper. They are interdependent, with the lack of availability of the writing implement being the more common problem. Research into prior art hasn't shown a device that can be generalized to deal with the many situations where availability of writing implements is needed. Products being

Products developed for the current market lack versatility. In the past the problem has for the most part been ignored, and left to the improvisational instincts of the individual consumer. Consider the ball-point pen slipped into the wire of spiral-bound notebooks, often lost. Consider a pencil held diagonally on a clipboard, under the clip and on top of the paper, and everything falls out. consider the coffee cups around the house, full of pens and pencils, and not always where needed. And, of course, the human ear. These improvisations, and many more, are real indications of a problem that needs to be solved.

Commercial solutions have mostly dealt with the problem on an individual basis; each specific situation receiving a specific solution. There are zippered pocket holders for loose-leaf binders. Holders mounted on clipboards designed for erasable marker pen. And, of course, the pocket-protector. There are loops and sleeves, generally crafted into writing kits or brief cases, generally made of fabrics, plastics, or leather. These iterations often appear to have been designed as an afterthought with low priority, or low budget, or all three. They tend to fall apart, come unstitched, or to stretch out and loose elasticity, all becoming useless.

The most interesting device found in the prior art search is U.S. Pat. No. 5,820,095, John W. Stone, Oct. 13, 1998. It appears to have been initially designed to hold marker pens, and then generalized to hold pens and pencils. The device performs well holding markers in the lecture-demonstration mode, but not as well with smaller writing implements, having the following problems:

a. The device protrudes too high from whatever it is mounted onto. Its highest point from its base is about 1.4 cm, approximately twice the diameter of the typical writing implement it was designed to hold, higher than many common notebooks are thick. Thickness would create problems with stacking, shelving, and when transported in a briefcase.

b. The height of the device from its base remains the same whether a writing implement is in place, or the device is empty.

c. The protruding edges and corners at each end are sharp and obtrusive.

d. The device is made from an extruded material that is not as resilient as it needs to be to hold the variety of sizes as claimed. This lack of resiliency manifests when changing from one size implement to another, especially when changing to a smaller implement.

e. The above criticisms combines to suggest a device that is not as versatile as is needed by the consumer.

### SUMMARY

In accordance with the present invention a holding device for writing implements and other implements of similar shape. The essence of the invention is the pattern contained within the device that holds the implements, comprised of entry ports and holding edges. The pattern can be:

a. Contained within a material that is part of something else, such as the cover material of a notebook. Hereafter referred to as the preferred embodiment.

b. Contained minimally within a material, with an adhesive added to the underside, enabling the holding device to be mounted wherever the user deems practicable. Hereafter referred to as embodiment 2.

Objects and Advantages

Accordingly, besides the objects and advantages of the holding device described in my above patent, several objects and advantages are:

a. to provide a device that is versatile. Prior art has not shown a device that can be generalized effectively to deal with the many situations where availability of writing implements is needed: within the cover materials of notebooks, mounted onto the cover of notebooks, mounted onto or around computers, telephones, clipboards, wherever the user thinks is appropriate.

b. to provide a holding device that is easy to use. The visual effect the device has on first sight suggests without instruction: what it does, how the writing implement is removed, and how the writing implement is to be inserted.

c. to provide an ergonomically safe holding device. In the case of the preferred embodiment the writing implement is held flat against the material the device is integrated into. Therefore the height from the base is equal to the diameter of writing implement. In the case of embodiment 2, the height from the base is equal to the diameter of the writing implement plus the thickness of the material the device is made of. The holding edges of both embodiments collapse downward when the writing implement is removed, to approximately 0.5 cm. Additionally, there are no sharp corners or edges to snag or cut anything. Thus a more ergonomically sound device.

d. To provide a holder that physically connects paper and writing implement. The best example is the preferred embodiment, wherein the invention is integrated into the cover material of a notebook. A second example is embodiment 2, wherein the invention is integrated into a body material, and then adhered onto the cover material of a notebook.

e. To provide a holding device that protects the surface mounted upon from being soiled by the implement, or fingers.

f. The width of the area between the holding pattern and the perimeter shape serve To provide an esthetically pleasing device that is easy to see, especially if the color is strongly contrasted with its surroundings. Colors may be used to convey specific information: red for danger, yellow for caution, green for go, etc.

g. Both embodiments provide to remind the user whether or not there is a writing implement at hand.

h. To provide a holding device that can be made from a variety of materials and processes. Both embodiments could be manufactured from various plastics, and papers, or other materials that are flexibly, and resiliently suitable. processes of manufacture would be those suitable to the material, injection molding, die-cutting are the most obvious for plastics and papers.

i. To provide a holding device of embodiment 2 that allows the user to choose where to mount the device, onto: books and notebooks, computers, telephones, kitchens, workshops, dashboards, wherever the user thinks appropriate.

j. To provide a holding device of embodiment 2 that can accept commercial printing around the flat perimeter portion, for promotional advertising purposes.

k. To provide a holding device off embodiment 2 that can be modified into other products while maintaining integrity as a holder of writing implements. The perimeter of embodiment 2, in its present form, confines the holding device and adhesive, in a efficient, minimal, and visually pleasing way. For promotional advertising and other product purposes the shape of the perimeter, outside of the adhesive area could be anything a designer might create: trademarks, fictional characters, or information.

l. To provide a holding device which will hold writing implements of various diameters, including most common brands of ball-point pens, and wooden or mechanical pencils.

m. To provide a holding device for writing implements that is inexpensive and durable.

Further objects and advantages of my invention will become apparent from a consideration of the drawings and ensuing descriptions.

### DRAWING FIGURES

FIG. 1 shows a top perspective of the preferred embodiment integrated into the cover material of a spiral-bound notebook, with pencil inserted.

FIG. 2 shows an enlarged top view of the pattern of the preferred embodiment.

FIG. 3 shows an enlarged side view of the preferred embodiment.

FIG. 4A shows an enlarged end view of the preferred embodiment.

FIG. 4B shows an enlarged end view of the preferred embodiment with a ball-point pen inserted

FIG. 5 shows a top perspective view of embodiment 2 with a pencil inserted.

FIG. 6 shows a top view of embodiment 2, including the adhesive pattern.

FIG. 7 shows a top view of the alternative pattern of holding edges, and longitudinal ridges, of embodiment 3

FIG. 8 shows an end view of embodiment 2, with a writing implement inserted.

FIG. 9 shows an end view of embodiment 3 including longitudinal ridges, and holding fingers looped over the inserted writing implement.

FIG. 10 shows prior art—U.S. Pat. No. 5,820,095 Stone Oct. 13, 1998.

Numerals In Drawings

20 holder pattern
22 entry port
24 entry port point
26 entry port curve
28 holding arm
30 holding edge
32 impressed line
34 holder base
36 holder body
38 adhesive pattern
40 rounded corner
42 hinging area
44 perimeter
46 channel
48 longitudinal ridge
50 holding fingers
52 tortuous edges
54 tortuous path

### DESCRIPTION OF PREFERRED EMBODIMENTS

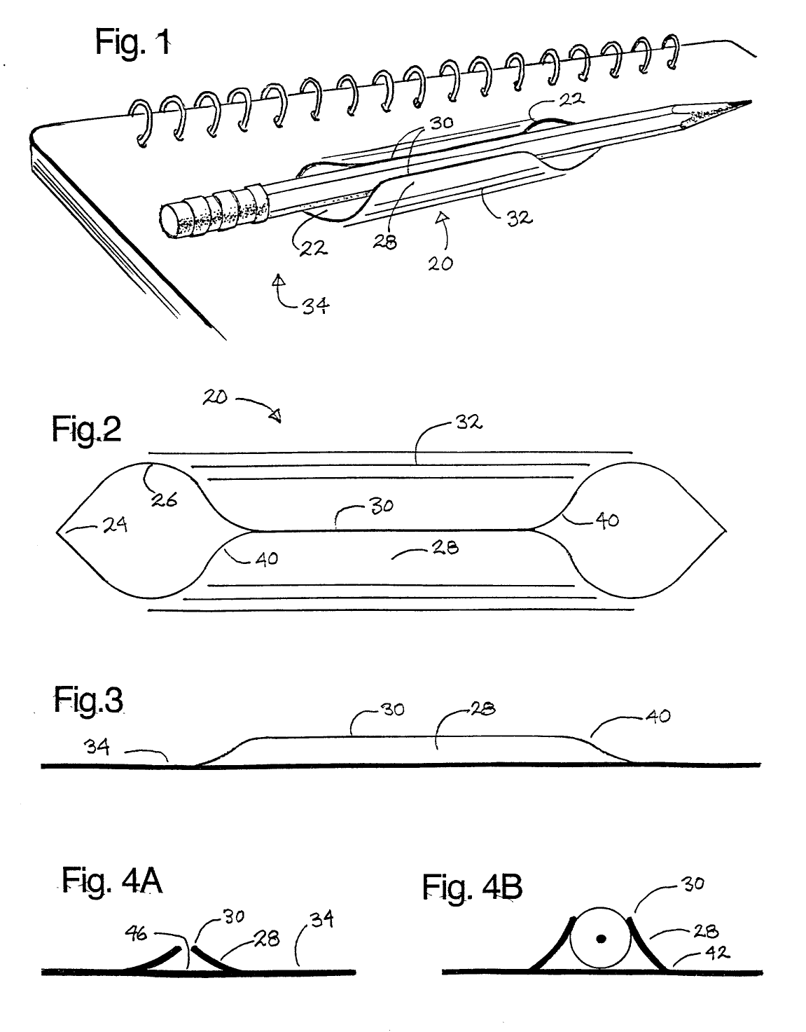

The invention described herein is a device for holding writing implements that is operative in two distinctly different applications, both evolving from the holder pattern 20 illustrated in FIG. 2. The preferred embodiment is integrated into something else, embodiment 2 is adhered onto something else.

The preferred embodiment is essentially a pattern cut or molded into a suitable material that is part of something else. FIG. 1 shows the device integrated into the cover material of a spiral-bound notebook, with a pencil in place. FIG. 2 is an enlargement of the holder pattern 20 comprising: two entry ports 24, two combination holding arms 28 and holding edges 30, and two sets of impressed lines 32. The two sets of combined holding arms 28 and edges 30 are mirror imaged and contiguous, and connect to mirror imaged entry ports 24 at each end. The configuration looks like a thin spear shaft with a spearhead at both ends: entry ports 22 represented by the opposite pointing spearheads, contiguous holding edges 30 represented by the connecting spear shaft. A plurality of mirror imaged impressed lines 32 parallel holding edges 30 between the outer arcs of each entry port 22. Holder pattern 22 is symmetrical in vertical and horizontal orientation.

Entry port 22 is a void in the cover material of FIG. 1 and FIG. 2 comprising the entry port point 24, and entry port curve 26, and rounded corners 40. The area of the entry port 22 is defined by: two lines diverging from a point on an axis, in a mirrored, symmetrical fashion, at about 45 degree angles. The angles end as they connect with the outermost perimeter of a concentric circle, curving back and ending on the line of the axis. There is a mirrored, and opposite entry port 22 on the axis some distance away. A line cut through the holder base 34 material along the line of the axis connects the two entry ports 22, and defines the contiguous holding edges 30. FIG. 3 shows a rounded corner 40 operative a transition between entry port 22 and holding edge 30. Impressed lines 32 are a plurality of lines pressed into the area of transition between the holder base 34 and the holding arm 28, and are longitudinally centered between, but not touching, the outer part of entry port curves 26.

FIGS. 1 thru 4B show various views of holding arms 28, and holding edges 30. Holder pattern 20 comes to the consumer in a flat manner, planar to the holder base 34 material. Holding edges 30 are contiguous. Holding edges 30 are the terminal edges of holding arms 28, terminating on the axis line. The holding edges transition into the entry ports at rounded corners 40. The holding arms begin approximately on a line between the curved outer portion of the entry ports, along the longitudinal impressed lines 32. As best shown in FIG. 4B before an implement is inserted the holding arms angle slightly upward toward each other and are slightly open. When an implement is inserted, best seen in FIG. 4B, the holding arms are forced upward and outward, thus creating the clamping force.

FIGS. 1 and 2 show impressed lines 32. The impressed lines are very shallow impress-ions formed into the holder body material as the holder pattern is being manufactured, operative to the consumer preparing the holding arms 28 for use. when the material the holder pattern is being integrated into is paper, impressed lines 32 create a hinging area 42 that facilitate forming holding arms 28. The use of impressed lines 32 may be included or excluded on various applications of all embodiment.

Summarizing: A channel 46, triangular in cross section, is created between holding edges 30 and holder base 34 that are in direct contact with the writing implement, and form a three-point clamping action.

The preferred embodiment herein has used a notebook application to illustrate its many advantages, considered a best-use application. Many other applications are possible that integrate into the body material of other manufactured things, the potential to hold writing implements.

Operations—Preferred Embodiment

FIGS. 1 thru 4B show a device for holding writing implements that has been integrated into something else. FIG. 1 is a top perspective view with a pencil intact. The application used here to illustrate the operation of embodiment 1 is a spiral-bound notebook, considered to be a best-use, but is not to be considered as limiting in any other applications.

The notebook would come to the consumer with holder pattern 20 most likely die-cut through the cover material, flat and planar. In cover materials made of paper the pattern would be flanked by impressed lines 32. Impressed lines 32 facilitate the forming of holding arms 28, and holding edges 30, that prepare the device for holding. The holding arms and edges are formed by: Partially open the cover and insert a pen or pencil down into either entry port 22; slide the pen under holding edges 30, along channel 46, up and out of the opposite entry port, longitudinally centering the pen in the holding edges 30; permanently form the holding arms and edges by simultaneously rubbing, with thumb and forefinger, firmly along impressed lines 32. The pen or pencil may be removed from the holding device by: gripping the implement at either end, lifting it perpendicularly, forcing the holding edges apart, freeing the implement; or by sliding the implement, parallel with the axis, out through either entry port. A pen or pencil may be inserted into the holding device by: Hold the implement near parallel to the axis at either entry port; insert the implement's point into channel 46, under and along the holding edges; slide the implement along the channel and out through the opposite entry port. Thus is provided a notebook with a built-in pen or pencil holder.

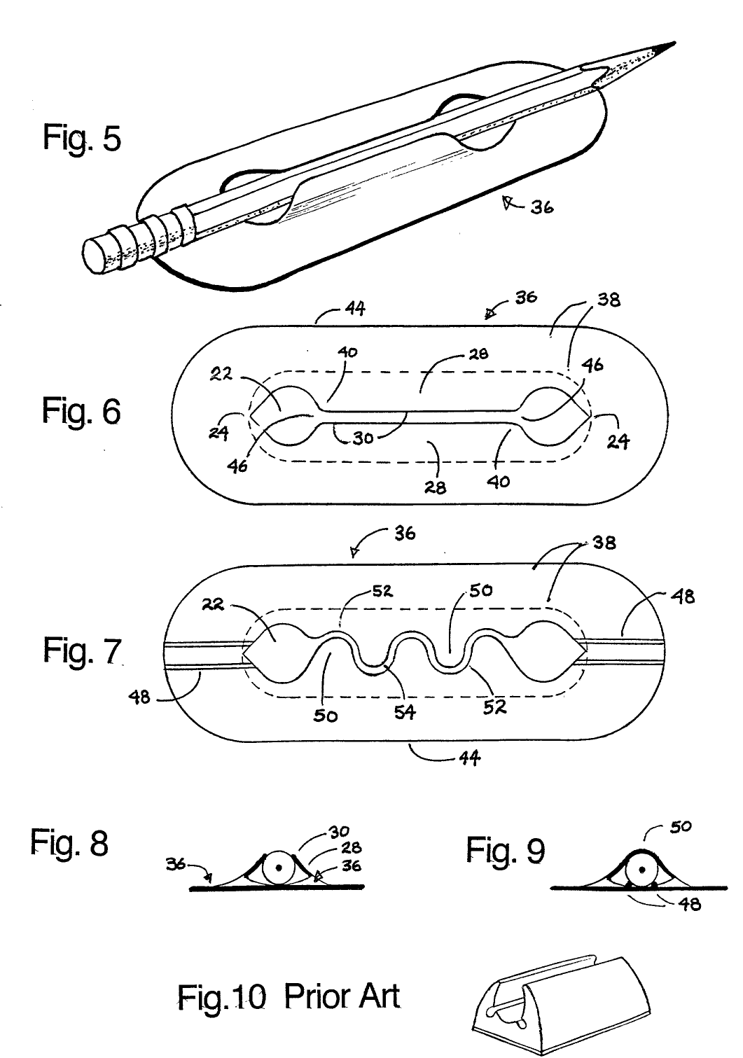

Description Embodiment 2—FIGS. 5, 6, and 8

Embodiment 2 is a device for holding writing implements that can be adhered onto something else. FIG. 5 shows a top perspective view of my invention with a pencil in place. Embodiment 2 uses the holder pattern 20 of the preferred embodiment, and surrounds the pattern with a holder body 36. Holder body 36 is an elongated oval shape with flattened sides, made from a thin, flexibly resilient, material, approximately the thickness of a credit card. A perimeter shape 44 is considered efficient to surround holder pattern 20 and provide an area on the underside for the adhesive. As shown in FIG. 6 an adhesive pattern 38 is defined by the area just outside of holder pattern 20 outward to the perimeter of the holder body. Thus operative to adhere the device for holding writing implements anywhere the consumer thinks practicable. As best seen in FIG. 8 the implement is held within the device at three points, the two holding edges 30 and holder body 36.

Operations—Embodiment 2

FIGS. 5, 6, and 9 show a device for holding writing implements that can be adhered to something else. FIG. 5 shows holder pattern 20 surrounded by a holder body 36, with an adhesive 38 on the underside covered by a protective material. Thus enabling the device to be mounted wherever the consumer thinks appropriate: walls, calendars, notebooks, wherever. Embodiment 2 would be mounted onto the cover of a spiral-bound notebook in the following way: select the positioning of the device and insert a pen or pencil; remove the protective covering from the adhesive; holding both ends of the pencil, carefully reposition the holder device and press down; remove the pencil from the holder and thoroughly rub the adhesive down.

Description Embodiment 3—FIGS. 7 and 9

Embodiment 3 is a modification of embodiment 2 and is a device for circumstances calling for a very high degree of holding potential. FIG. 7 shows a top view of the modifications of embodiment 3. The heretofore straight path between holding edges 30 becomes a tortuous path 54. Holding arms 28 transition into a plurality of holding fingers 50 that terminate as a tortuous edge 52. From opposite sides a plurality of holding fingers 50 curve up over and slightly down the top portion of channel 46, alternately, like interlaced fingers, greatly increasing holding power. FIG. 9 shows an end view with a writing implement inserted, indicating the overlapping of the holding fingers 50. The holding arms and fingers collapse downward when the implement is removed.

FIGS. 7 and 8 show a pair of small longitudinal ridges 48, about 1.5 mm high, formed up out of holder body 36, approximately 1 cm apart, paralleling the axis of the holder body, and extending from perimeter 44 axially, to the opening of entry port 22. When a writing implement is inserted longitudinal ridges 48 flank the implement, laterally stabilizing the implement along the line of the axis.

Summarizing: A channel 46, is created between holding fingers 50 and holder body 30 that come directly in direct contact with the writing implement, and form a surrounding clamping action.

Operations—Embodiment 3

FIGS. 7 and 9 show two modifications to embodiment 2 for special circumstances where a higher degree of holding power is desired:

1. A mirrored pair of longitudinal ridges 48 are formed into the holder body 36 at both arched ends. Longitudinal ridges operative to restrict the lateral motion of the writing implement, providing more security.

2. Modified holding edges, defined by tortuous edges that look similar to interlaced fingers; looping over the implement providing more security. It is recommended that the writing implement be removed by sliding it out of either entry port; the reverse of the entry procedure.

Conclusion, Ramifications, and Scope

Thus the reader will see that the invention described herein provides a device for holding writing implements that is easy to use, reliable, and highly versatile in its application. A device that everyone who writes could find useful. While my above description contains three embodiments and many specificities, these should not be construed as limitations on the scope of the invention, but rather as exemplifications of the three embodiments thereof. Many other variations are possible. For example:

a. Modify the present devices to hold a plurality of writing implements. Other embodiments could hold two or many more implements, for artists or students.

b. Modify the embodiments to hold a variety of implement sizes.

c. Embodiment 2 wherein the holder body is modified to carry books and notebooks for recording and displaying information.

d. A combination notebook-pencil holder-pocket protector that can be folded and fit into purse or pocket, and protect each from the other.

e. Embodiment 2 and 3 may include a clip device rather than an adhesive. The device would then be transferable.

f. Embodiment 2 and 3: may extend the two lobes of the holder body sufficiently to shield whatever the holder body is mounted on from the writing implement.

I claim:

1. A device for holding writing implements, most fundamentally a holder pattern that is a means for holding that can be integrated into other things, and function as an independent device to be adhered onto other things, said holder pattern comprising:
a. A pair of holding arms terminating distally as holding edges, that rise up angularly out of a base material from opposite longitudinal sides forming a triangularly shaped channel, whereby said writing implement may be held within.
b. A pair of mirrored entry ports connect to the ends of said holding arms and edges at both openings of said channel, and transition down and away obliquely, from the longitudinal axis, curving back obliquely, straightening to form a point at each end, planar with said base material, top view of said pattern looking like a spear shaft with spearhead attached at both ends, said holding edges represented by the spear shaft and said entry ports represented by the opposite facing spearhead, the oblique angles within said entry ports whereby operative to facilitate insertion of ball point pens and mechanical pencils having concentrically stepped ridges in the transition between the holding cylinder portion and the writing tip, whereby combination of said holding arms and edges, and said entry ports form said holding pattern operative to be integrated into other things, as into the cover materials of various notebooks or other things,
c. said pattern for holding integrated into a holder body material sized to functionally support said holding pattern including an adhesive pattern on the underside of said holder body said adhesive pattern located outside said holding pattern outward to the perimeter of said holder body, said adhesive to include a protective covering, whereby said independent device operative to mounting onto other things such as the cover materials of notebooks.

2. The holder of claim 1 wherein said holding pattern is integrated into other things, and where it may be economically and ergonomically expedient to require the user to form said holding arms and edges, a plurality of impressed lines close and parallel, located longitudinally centered between the outside curves of said entry ports and parallel with said holding edges, said impressed lines terminating just short of said entry ports, whereby facilitating the forming of the arms and edges, the use of said device being optional.

3. The holder of claim 1 wherein a perimeter shape for said holder body is an elongated oval with two elongated sides flat and parallel and the two ends symmetrically rounded, sufficiently sized whereby said holder is minimal and effective for containing said holding pattern and mounting said holder onto other things.

4. The holder of claim 1 wherein a perimeter shape of said holding body is unlimited, whereby said perimeter shape may be modified to serve promotional advertising, or other commercial purposes.

5. The holder of claim 1 wherein said holder body is modified to contain a plurality of said holder patterns whereby a plurality of writing implements can be held therein.

6. The holder of claim 1 wherein said holder body is enlarged and modified to hold said holder pattern, and removable and replaceable books and notebook.

7. The holder of claim 1 wherein said holding arms and edges of said means for holding is operative to rising during the insertion of an implement, and collapsing as the implement is being removed, whereby said device becomes less obtrusive.

8. The holder of claim 1 wherein all corners are rounded, whereby reducing potential for snagging and cutting.

9. The holder of claim 1 wherein said holding arms and edges become a tortuous path at their closest point, forming an interlaced finger-like configuration, alternately overlapping said writing implement within said channel, whereby holding power is greatly increased.

10. The holder of claim 1 wherein a pair of small longitudinal ridges are formed into said holder body between the opening of said entry ports and the perimeter of said holder body, whereby longitudinal ridges operative to restrict the lateral motion of the writing implement when held within, providing more stability.

11. The holder of claim 1 wherein said holder pattern is formed from a single piece of suitable material, not limited to, but including: plastics, papers, rubbers, metals, leather, or combinations such as plastic coated paper.

12. The holder of claim 1 wherein said holder is manufactured using processes including but not limited to: die-cutting, injection molding, vacuum forming, heat forming, extrusion, or combinations thereof.

13. The holder of claim 1 wherein said holder device is the result of forming upward from said holding pattern, said holding arms and edges.

14. The holder of claim 1 wherein said holding pattern comprising two entry ports connected by the opening between the two holding edges is a single opening, whereby said holder device is formed from the single opening.

15. The holder of claim 1 wherein the color of said holder body can be informational or decorative.

16. The holder of claim 1 wherein said holder may be modified to hold other implements, instruments, tools, or objects of like shape.

17. A holder device for writing implements that is a means for holding pattern comprising:
a. a holding arm that ends distally as a holding edge opposed and mirror imaged along an axis, said opposite arms and edges rising angularly up out of a base material converging toward one another to terminate close but not touching, said base material and said holding arms and said holding edges combine to form a channel triangularly shaped and elongated, so to receive and securely hold elongated writing implements, said channel elongated having opposite open ends that transition into entry ports,
b. said entry ports are located and connected at each end to said holding arms and edges, said entry ports curve obliquely away from the longitudinal axis, curving back circularly and meeting obliquely at a point on the axis, whereby said entry ports sized to provide a hinging area required by said holding arms and edges.

18. The holder of claim 17 wherein said holder pattern is integrated into something else such as the cover material of notebooks, whereby the notebook is enabled to conveniently coordinate something to write with, and something to write on.

19. The holder of claim 17 wherein said holder pattern is integrated into an independent holder body material sized to functionally support said holding pattern, including an adhesive pattern located from just outside said holding pattern outward to the perimeter of said holder body material, said adhesive to include a protective covering material over said adhesive, whereby said holder device operative to mounting onto other things such as the cover materials of notebooks.
